(19) United States
(12) Patent Application Publication
(10) Pub. No.: US 2021/0176998 A1
(43) Pub. Date: Jun. 17, 2021

(54) High Protein High Fiber Bread with Added Spices

(71) Applicant: Cameron V. Parast, Pacifica, CA (US)

(72) Inventor: Cameron V. Parast, Pacifica, CA (US)

(21) Appl. No.: 16/716,021

(22) Filed: Dec. 16, 2019

(51) Int. Cl. A21D 13/045; A21D 8/04; A23L 27/10; A23L 33/105; A21D 2/36; A21D 2/14

(52) U.S. Cl. CPC A21D 13/045; A21D 8/047; A21D 2/14; A23L 33/105; A21D 2/36; A23L 27/105

(57) ABSTRACT

A bread product made from beaten eggs and flour high in fiber such as rye. Various spices such as ginger which are known to lower A1C and cholesterol are added to the dough to achieve a bread product which upon consumption delivers therapeutically effective concentrations of the spices.

### FIELD OF INVENTION

This invention relates to a bread product high in fiber and high in protein. The bread product is made from a yeast leavened dough. The flour is generally a mixture of gluten and one other flour such as rye, barley, lentil, chickpeas. Beaten egg is used as water substitute. Therapeutically effective concentrations of ginger and other ingredients are added to the dough.

### BACKGROUND OF INVENTION

Obesity and type two diabetes as well as high cholesterol are affecting increasing number of people. These metabolic diseases are currently being treated as medical conditions and many therapeutics have been developed. However, it has become increasingly evident that therapeutics is the last resort for treatment of most metabolic diseases. Diet and exercise are the key factors. In this invention, diet is the main focus for management of type-2 diabetes and high cholesterol and obesity.

There is a great need for food high in soluble fiber and protein. Food high in soluble fiber are digested at a lower rate than simple carbohydrates and therefore lead to lower blood glucose. Soluble fiber also absorbs cholesterol in food which reduces its absorption through the gut. High protein food helps in regulating appetite by giving feeling of satiety. Bread is one of the staples of every diet. Most people consume 2-4 slices of bread. Significant portion of dietary fiber and protein can be delivered through consumption of bread.

Some spices have been shown to lower HbA1C as well as cholesterol. For example, ginger at 2 g per day has been shown to lower HbA1C by 1 point as has also been shown to lower bad cholesterol and increases good cholesterol. Addition of ginger to bread to achieve therapeutically effective concentrations would be of great value to consumers who would like to lower their A1C and cholesterol through diet.

Cinnamon also reduces HbA1c and fasting glucose plasma at concentrations of 0.2-6 grams per day. Cinnamon was found to be less effective than ginger. Turmeric consumption between 0.5-1.5 grams per day is considered therapeutic. Theracurmin (180 mg per day), a soluble form of curcumin, the active ingredient of turmeric has also been shown to reduce HbA1c and cholesterol. Most studies of garlic use 0.6-1.2 grams per day to achieve therapeutic results. In place of ground spices, their corresponding active ingredients could be used. Active ingredients of ginger are 6-gingerol, 6-shogaol, 6-paradol, zingiberene, bisabolene. Active ingredient of garlic is allicin. Active ingredient of turmeric is curcumin. Theracurmin is a soluble form turmeric. Active ingredients of cinnamon are cinnamaldehyde and cinnamate. Active ingredient of clove is eugenol.

### BRIEF SUMMARY OF THE INVENTION

This invention provides a solid component and a liquid component. The liquid component is beaten whole egg or egg white. The solid component is a mixture of a vital wheat gluten and a flour high in fiber such as rye, barley, lentil, chickpeas, etc. The present invention also provides a bread product which contains effective concentrations of spices which are demonstrated through clinical studies to reduce A1C and cholesterol. Such spices include ginger, garlic, cinnamon, cloves, turmeric.

### DETAILED DESCRIPTION OF THE INVENTION

Due to current pandemic of obesity, currently there is a great need for bread products which are high in protein content and high in soluble fiber. High protein content is known to lead to a feeling satiety and therefore reduced appetite. High soluble fiber leads to slow release of carbohydrate, and it also promotes healthy bowl movement and healthy intestinal microbe population. Currently there are many varieties of whole wheat breads available in the market, but these products deliver insoluble fiber in the form of bran. Bread products high in insoluble fiber generally don't taste good. There are also some high protein bread products in the market. But there is no bread product which contains high protein content as well as high soluble fiber content.

Bread is one of the main categories of food which nearly everyone consumes daily. Therefore, bread can be formulated to deliver therapeutically effective amounts of natural spices and other natural ingredients which are known to lead to desired outcome. Ginger has been studied in clinical trials and it has been shown that 2 grams of ginger powder per day results in significant reduction in A1C, cholesterol and triglyceride. Similar studies are done with cinnamon, cloves, garlic, turmeric.

In the preferred embodiment of this invention, rye flour is mixed with gluten flour in a ratio of 2/3 rye and 1/3 gluten. Small amount of yeast is also added to the flour mix. Separately, whole eggs or egg white is beaten. The resulting beaten egg is used as the liquid for making a dough. Generally, by volume, 1/2 as much liquid is needed to form an ideal dough. Vegetable oil is also added to form a softer dough. The resulting dough is allowed to rise at room temperature for a 1-3 hours prior to baking. The resulting bread is very light and fluffy, tastes good and has a long shelf life.

The following is a typical recipe which makes three loaves.

| | | | Protein | Fiber | Fat | Carbohydrate | |
|---|---|---|---|---|---|---|---|
| | Amount | | g | g | g | g | Calories |
| Rye | 4 | cups | 72 | 116 | 13.6 | 352 | 1556 |
| Gluten | 2 | cups | 42 | | 0 | | 116 |
| Eggs | 12 | each | 72 | | 60 | | 936 |
| sugar | 5 | tbs | 0 | | | 15 | 52 |
| Oil | ¼ | cup | 0 | | 54 | | 447 |
| Per Loaf | | | 93 | 58 | 63.8 | 184 | 1603 |
| Per Slice | | | 4.7 | 3 | 3.2 | 9.1 | 80 |

In another embodiment, 60 g of ginger is added to the flour mix in the previous recipe which results in 1 g of ginger per slice of bread. Consumption of two slices of this bread deliver 2 grams of ginger which is shown to result in reduction in A1C, cholesterol, and triglyceride. This bread has a very mild ginger flavor.

In another embodiment, ginger is replaced with garlic or cinnamon or turmeric or clove powder.

In an alternative embodiment, ginger or other spices are replaced with their active ingredients.

| | Protein g | Fiber g | Fat g | Carbohydrate g | Calories |
|---|---|---|---|---|---|
| Per Slice | 4 | 1.3 | 2.7 | 10 | 80 |

In another embodiment, chickpea flour is used instead of rye flour in a recipe similar to that of the preferred embodiment mentioned earlier. This dough results in two loaves instead of three.

| | Protein g | Fiber g | Fat g | Carbohydrate g | Calories |
|---|---|---|---|---|---|
| Per Slice | 5 | 1 | 3.5 | 5.7 | 74 |

In additional embodiments, rye flour is replaced with lentil, barley or whole wheat flour.

In another embodiment, various mixtures of these flours are used.

In another embodiment, wheat flour is mixed in with bran and gluten flour in a ratio of 3/8, 3/8, 1/4. Small amount of yeast is also added to the flour mix. Separately, whole eggs or egg white is whipped. The resulting whipped egg is used as the liquid for making a dough. Generally, by volume, 1/2 as much liquid is needed to form an ideal dough. Vegetable oil is also added to form a softer dough. The resulting dough is allowed to rise at room temperature for a few hours prior to baking.

The resulting bread is very light and fluffy, tastes good and has a long shelf life.

| | Protein g | Fiber g | Fat g | Carbohydrate g | Calories |
|---|---|---|---|---|---|
| Per Slice | 5 | 2.1 | 3.5 | 10.3 | 95.6 |

In another embodiment, wheat flour is mixed in with flaxseed meal, chia seeds and gluten flour in a ratio of 3/8, 1/4, 1/8, 1/4. Small amount of yeast is also added to the flour mix. Separately, whole eggs or egg white is whipped. The resulting whipped egg is used as the liquid for making a dough. Generally, by volume, 1/2 as much liquid is needed to form an ideal dough. Vegetable oil is also added to form a softer dough. The resulting dough is allowed to rise at room temperature for a few hours prior to baking.

| | Protein g | Fiber g | Fat g | Carbohydrate g | Calories |
|---|---|---|---|---|---|
| Per Slice | 7 | 4.8 | 6.7 | 9.4 | 140 |

1. A high protein, high fiber baked bread product composition comprising 1/2-3/4 by volume first flour selected from a group consisting of rye flour, barley flour, chickpea flour, lentil flour, whole wheat flour; and 1/2-1/4 by volume vital wheat gluten flour kneaded into a dough by addition of exogeneous yeast and a liquid portion selected from group consisting of beaten whole eggs and egg white, followed by baking.

2. Bread product of claim 1 where one or more spices are added to the flour composition prior to baking where spices are selected from a group consisting of ground ginger, garlic, cinnamon, clove and turmeric; spices are added to achieve 0.5-50 grams of each spice per loaf.

3. Bread product of claim 1 where one or more active ingredients of ginger, garlic, cinnamon, clove, and turmeric is added to the flour or liquid composition prior to baking where active ingredients are selected from a group of 6-gingerol, 6-shogaol, 6-paradol, zingiberene, bisabolene, allicin, curcumin, Theracurmin, cinnamaldehyde, cinnamate, and eugenol; active ingredients are added to achieve a 0.1-10 gram of each ingredient per loaf.

4. A high protein, high fiber baked bread product composition consisting of wheat flour 3/8, vital wheat gluten flour 1/4, chia seeds 1/8, and another ingredient 1/4 selected from a group consisting of flaxseed meal, almond meal, pistachio meal kneaded into a dough by addition of exogeneous yeast and a liquid portion selected from group consisting of beaten whole eggs and beaten egg white, followed by baking.

5. Bread product of claim 3 where one or more spices are added to the flour composition prior to baking where spices are selected from a group consisting of ground ginger, garlic, cinnamon, clove and turmeric; spices are added to achieve 0.5-50 grams of each spice per loaf.

6. Bread product of claim 4 where one or more active ingredients of ginger, garlic, cinnamon, clove, and turmeric is added to the flour or liquid composition prior to baking where active ingredients are selected from a group of 6-gingerol, 6-shogaol, 6-paradol, zingiberene, bisabolene, allicin, curcumin, Theracurmin, cinnamaldehyde, cinnamate, and eugenol; active ingredients are added to achieve a 0.1-10 gram of each ingredient per loaf.
